(19) United States
(12) Patent Application Publication
(10) Pub. No.: US 2025/0238030 A1
(43) Pub. Date: Jul. 24, 2025

(54) SAFE STATE TRIGGER

(71) Applicant: Infineon Technologies AG, Neubiberg (DE)

(72) Inventors: Benno Koeppl, Markt Indersdorf (DE); Timo Dittfeld, München (DE)

(21) Appl. No.: 18/978,978

(22) Filed: Dec. 12, 2024

(30) Foreign Application Priority Data
Jan. 23, 2024 (DE) 102024101827.5

(51) Int. Cl. G05B 23/02

(52) U.S. Cl. CPC G05B 23/0291

(57) ABSTRACT

An electronic control unit (114) is presented. The electronic control unit (114) comprises at least:
an electronic device (120);
an application controller (122) configured for controlling the electronic device (120); and
a safe state trigger (124) configured for:
   monitoring input signals sent from a supervising controller (112) to the electronic control unit (114);
   identifying a failure signal from the input signals; and
   sending a safe state signal to the electronic device (120) when identifying the failure signal.

Further, a method for triggering a safe state, a control system (110) and a use of the electronic control unit (114), the method or the control system (110) are presented.

### TECHNICAL FIELD

The present disclosure relates to an electronic control unit, a method for triggering a safe state, a control system and a use thereof.

### BACKGROUND

Safety relevant applications, e.g. in the automotive field, typically require safe states, which can be entered in case of failure events. As an example, a motor may be turned off in an automobile in case of an identified malfunction of the motor or motor control electronics to prevent further damage. Such safety relevant applications are further typically at least indirectly monitored by more than one controller or entire electronic control unit. The electronic control units may have different hierarchies. As an example, an automobile may be controlled by a central electronic control unit or by several zone electronic control units which may again control application electronic control units for different applications in the automobile. A higher hierarchy electronic control unit may receive and process more data, e.g. from different sensors, and may thus have more information available for identifying a failure event compared to a lower hierarchy electronic control unit. Correspondingly, the higher hierarchy electronic control unit may also comply with a higher safety integrity level preventing malfunctioning. Thus, the higher hierarchy electronic control unit may follow stricter safety-related design principles, which reflects in complexity and eventually in cost. In case of an identified failure event, the higher hierarchy electronic control unit may send a failure signal to a lower hierarchy electronic control unit for triggering a safe state of the application. Thus, for maintaining the overall safety integrity level, at least the components of the lower hierarchy electronic control unit which further process the failure signal should also comply with the higher safety integrity level. This in turn typically increases complexity and thus also cost for those components.

### SUMMARY

In a first aspect, an electronic control unit is presented. The electronic control unit comprises at least an electronic device, an application controller and a safe state trigger. The application controller is configured for controlling the electronic device. The safe state trigger is configured for monitoring input signals from a supervising controller to the electronic control unit. The safe state trigger is further configured for identifying a failure signal from the input signals. The safe state trigger is further configured for sending a safe state signal to the electronic device when identifying the failure signal.

In a further aspect, a method for triggering a safe state is presented. The method comprises:
a) receiving input signals from a supervising controller at an electronic control unit comprising an application controller, a safe state trigger and an electronic device;
b) monitoring the input signals by using the safe state trigger; and
c) sending a safe state signal to the electronic device when identifying a failure signal from the input signals.

In a further aspect, a control system is presented. The control system comprises a supervising controller. The supervising controller is configured for controlling at least one electronic control unit. The control system further comprises at least one electronic control unit. The electronic control unit comprises at least an electronic device, an application controller and a safe state trigger. The application controller is configured for controlling the electronic device. The safe state trigger is configured for monitoring input signals from a supervising controller to the electronic control unit. The safe state trigger is further configured for identifying a failure signal from the input signals. The safe state trigger is further configured for sending a safe state signal to the electronic device when identifying the failure signal.

In a further aspect, a use of the electronic control unit and/or the method for triggering a safe state and/or the control system is presented for an automotive application.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIGS. 1 to 9 schematically illustrate examples of a control system according to the present disclosure; and

FIG. 10 illustrates a flow chart of an example of a method for triggering a safe state according to the present disclosure.

### DETAILED DESCRIPTION

The examples described herein provide considerable advantages over the prior art. The electronic control unit according to the present disclosure can at least partially decouple an internal safety path from a main control path by using a safe state trigger separate from an application controller. Thus, the application controller itself can comply with a lower safety integrity level reflecting in lower complexity and eventually in lower cost. The safe state trigger can specifically be used for leading the safety path around the application controller in the electronic control unit or in other words for bypassing the application controller. Consequently, a less expensive application controller may be sufficient for controlling the application while still meeting overall safety requirements.

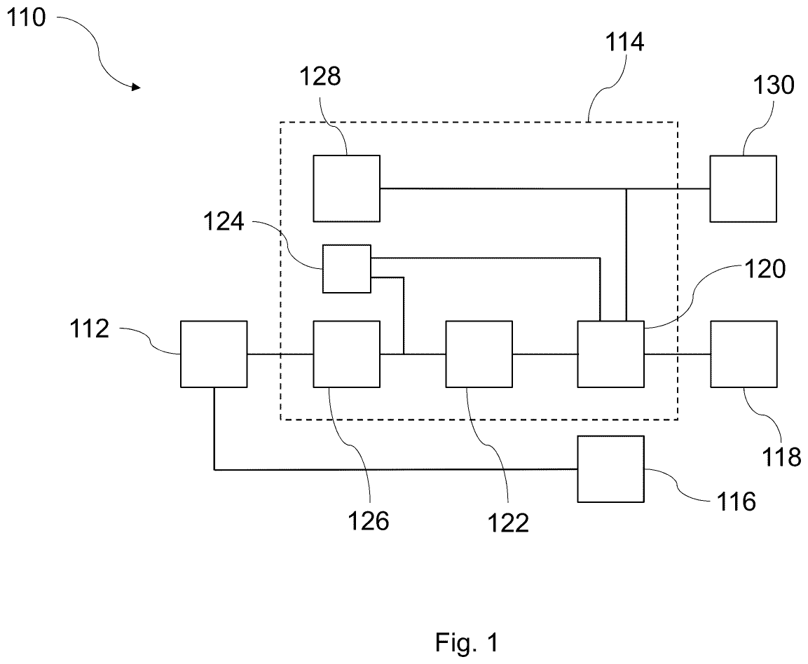

FIG. 1 schematically illustrates an example of a control system 110. The control system 110 comprises a supervising controller 112. The supervising controller 112 is configured for controlling an electronic control unit 114. The electronic control unit 114 may be an embedded system, specifically in an automotive application, e.g. for motor control. The supervising controller 112 may be configured for controlling further not shown electronic control units and may itself also be an electronic control unit or at least a part thereof. Thus, the supervising controller 112 may be a supervising electronic control unit or at least a part thereof. Specifically, the supervising controller 112 may be zone controller or a central controller. The control system 110 may specifically be a control system of an automobile. In this context, a central controller may be configured for at least indirectly controlling the entire automobile, e.g. by using subordinate controllers. A zone controller may be configured for controlling spatial or functional zones of the automobile. The supervising controller 112 may be or may comprise a microcontroller, specifically a main microcontroller of the control system 110. The supervising controller 112 may specifically comprise a central processing unit. The supervising controller 112 may specifically be configured for processing sensor data, such as for identifying a failure event.

The control system 110 may comprise a sensor 116. The sensor 116 may be configured for observing the control system 110 or at least a part thereof. Specifically, the sensor 116 may be configured for observing the electronic control unit 114. The electronic control unit 114 may be configured for controlling a load 118. The load 118 may be or may comprise a motor or an actuator for instance. Other applications may however also be possible. The load 118 may define the application of the electronic control unit 114. The sensor 116 may be configured for observing the load 118 additionally or alternatively to the electronic control unit 114. Thus, the sensor 116 may be configured for detecting a failure event, such as a failure of a motor. The supervising controller 112 may be configured for generating a failure signal in case of the failure event based on the sensor data. In other words, the sensor 116 may detect a failure and send corresponding sensor data to the supervising controller 112. Additionally or alternatively, the electronic control unit 114 may generate data, such as control data or also measurement data, and send it to the supervising controller 112.

The supervising controller 112 may identify a failure event from the received data, such as sensor data or data from the electronic control unit 114, and generate a corresponding failure signal which can be sent further. In other words, the failure signal may be based on data processed by the supervising controller 112, such as sensor data or control data. Thus, the failure signal may be a signal send by the supervising controller 112 indicating a failure event.

In principle, the control system 110 may of course also comprise further sensors or electronic control units for different applications, which is not shown for clarity reasons, and the supervising controller 112 may accordingly be configured for processing data from several components. Thus, the supervising controller 112 may be a central node in the control system 110 communicating with a plurality of components and processing a considerable amount of varying data. Consequently, malfunctioning of the supervising controller 112 could severely affect the control system 110 and should be prevented.

The supervising controller 112 may thus comply with a sufficiently high safety integrity level (SIL) or specifically with a sufficiently high automotive integrity level (ASIL). The IEC 61508 standard defines four SILs for functional safety, with SIL4 being the most dependable, followed by SIL3, then SIL2 and lastly SIL1 being the least dependable. Accordingly, the ISO 26262 standard defines four ASILs for the field of automotive with ASIL D having the highest safety requirements, followed by ASIL C, then ASIL B and lastly ASIL A having the lowest safety requirements. As an example, ASIL D refers to likely potential for severely life-threatening or fatal injury in case of a failure event, e.g. a loss of braking on all wheels of a car, and thus requires the highest safety level. Additionally, a further quality management (QM) level indicates that all assessed risks are tolerable from a safety perspective. The supervising controller 112 may for instance comply with a SIL4 or ASIL D.

The electronic control unit 114 may overall also comply with SIL4 or ASIL D. However, for such purpose, it may not be required that all of its components comply with SIL4 or ASIL D. The electronic control unit 114 comprises an electronic device 120. The electronic device 120 may for instance only comply with QM. The electronic device 120 may specifically be configured for controlling the load 118. As an example, the electronic device 120 may be or may comprise a switching device as will be outlined in further detail below. More generally, the electronic device 120 may be a semiconductor device. The electronic device 120 may specifically be or May comprise an integrated circuit. The electronic control unit 114 further comprises an application controller 122. The application controller 122 is configured for controlling the electronic device 120. Thus, the application controller 122 may at least indirectly be configured for controlling the load 118. The application controller 122 may be a microcontroller. The application controller 122 may be configured for performing the main processing functions of the electronic control unit 114. The application controller 122 may specifically be configured for receiving and processing input signals from the supervising controller 112 for controlling the electronic device 122 and thus at least indirectly the load 118. The application controller 122 may comply with a SIL lower than the SIL of a safety requirement of the electronic control unit 114, for instance lower than SIL4 or ASIL D. Thus, less expensive devices may be used for the application controller 122. Nevertheless, the overall SIL4 or ASIL D status may be maintained for the electronic control unit 114 as will be outlined in the following.

The electronic control unit 114 comprises a safe state trigger 124. The safe state trigger 124 may specifically be separate from the application controller 122. In other words, the safe state trigger 124 and the application controller 122 may be separate components of the electronic control unit 114. The safe state trigger 124 is configured for monitoring input signals sent from the supervising controller 112 to the electronic control unit 114, for identifying a failure signal from the input signals and for sending a safe state signal to the electronic device 120 when identifying the failure signal. Specifically, the safe state trigger 124 may be configured for bypassing the application controller 122 when identifying the failure signal and sending the safe state signal to the electronic device 120. Thus, there may be no involvement of the application controller 122 in the safety path. As a consequence, there may be no ASIL D requirement for the application controller 122 in the electronic control unit 114. The safe state trigger 124 may however comply with a SIL derived from or corresponding to a safety requirement of the electronic control unit 114, for instance with SIL4 or ASIL D.

The safe state trigger 124 may be configured for triggering a safe state in case of a failure event, e.g. a failure of the load 118 or of the electronic control unit 114, by sending the safe state signal to the electronic device 118. However, in principle, also other cases besides failure events may be conceivable for triggering a safe state. Thus, the safe state signal may specifically be a signal initiating a safe state, such as a safe state of the load 118. The electronic device 120 may be configured for putting the load 118 in a safe state, when receiving the safe state signal. The safe state may in particular be a safe state of the load 118 controlled by the electronic control unit 114 and specifically controlled by the electronic device 120. As an example, the safe state may be an OFF state of a motor. Additionally or alternatively, the safe state may be a safe state of the electronic control unit 114 or at least of a part thereof or even of the entire control system 110. Generally, the safe state may comprise at least one of an OFF state and an ON state. As an example, the safe state may comprise a dynamic change between the OFF state and the ON state, as for instance in a traction converter. Further, the safe state trigger 124 may be configured for triggering a transition mode of the electronic control unit 114 or at least a part thereof, e.g. the electronic device 120, for achieving the safe state. Thus, the transition mode may for instance comprise a dynamic change between an OFF state and an ON state or a soft stop, such as a gradually decreasing power supply to the load 118.

The safe state trigger 124 may be a signal filter 124 or may comprise at least one signal filter 124. The signal filter 124 may be configured for comparing the input signals with a predetermined fixed signal, specifically for identifying the failure signal. In particular, the safe state trigger 124 may be configured for sending the safe state signal when an input signal matches the predetermined fixed signal. The fixed signal may for instance be predetermined in a communication protocol used within the control system 110, specifically between the supervising controller 112 and the electronic control unit 114. The input signals sent from the supervising controller 112 to the electronic control unit 114 may specifically be or may comprise digital signals, also referred to as messages. In principle, analog signals may however also be feasible. Thus, the failure signal may be a specific digital signal or a specific message. Accordingly, the signal filter 124 may specifically be a digital signal filter 124, also referred to as a message filter 124. The signal filter 124 may comply with a SIL of a safety requirement of the electronic control unit, for instance with SIL4 or with ASIL D.

As illustrated in FIG. 1, the electronic control unit 114 may further comprise an interface 126. The interface 126 may be configured for connecting the electronic control unit 114 to at least the supervising controller 114. Specifically, the interface 126 may be a transceiver 126 or may comprise a transceiver 126 for communication of the electronic control unit 114 with the supervising controller 112. Additionally or alternatively, the interface 126 may comprise at least one bus for signal transfer. The bus may for instance be a digital serial bus. Other options may however also be feasible. The safe state trigger 124 may be configured for monitoring the signal transfer on the bus, which may also be referred to as sniffing or snooping the signal transfer on the bus. In other words, the safe state trigger 124 may observe input signals from the supervising controller 112 to the electronic control unit 114 and may specifically look for incoming failure signals from the supervising controller 112. The safe state trigger 124 may be configured for sniffing the signal transfer at an arbitrary position in the signal path, such as after the interface 126 or before the interface 126 or also at the interface 126 as will be outlined in further detail below. As will be outlined then, the safe state trigger 124 may specifically be implemented or incorporated in the interface 126. The interface 126 may further be configured for at least partially interconnecting components of the electronic control unit 114.

The electronic control unit 114 may further comprise a power adapter 128. The power adapter 126 may be configured for managing a power supply including conversion and monitoring. Thus, the power adapter 128 may be configured for being connected to at least one power supply 130. The power supply 130 may be configured for supplying the electronic control unit 114 and/or of the load 118 with electrical power. The power supply 130 may be part of the control system 110. In other words, the control system 110 may comprise the power supply 130. As an example, the power supply 130 may be or may comprise a battery 130. Thus, the power adapter 126 may for instance be configured for monitoring the battery 130, e.g. with respect to a battery lifetime, and/or for converting a battery voltage to a voltage applicable to the electronic control unit 114 and/or to the load 118. Specifically, the power adapter 128 may be a power management integrated circuit (PMIC) 128. As will be outlined in further detail below, the safe state trigger 124 may specifically also be implemented or incorporated in the interface 126 or in the power adapter 128.

Before, an exemplary operation of the control system 110 illustrated in FIG. 1 shall be outlined schematically in the following. The load 118, e.g. a motor, may be malfunctioning causing a failure event. The sensor 116 may continuously record sensor data regarding the load 118 and send the sensor data to the supervising controller 112. The supervising controller 112 may receive and process the sensor data and may thus recognize the failure event from the sensor data. Consequently, the supervising controller 112 may send a corresponding failure signal to the electronic control unit 114, such that the electronic control unit 114 controlling the load 118 can react to the failure event of the load 118. The safe state trigger 124 in the electronic control unit 114 may continuously monitor the input signals from the supervising controller 112 and may detect the failure signal. Consequently, the safe state trigger 124 may send a safe state signal directly to the electronic device 120, thereby bypassing the application controller 122. This may, as discussed, reduce safety requirements of the application controller 122, such that for instance less complex and expensive microcontrollers may be used while still maintaining the overall safety requirements of the electronic control unit 114. As an example, the application controller 122 may thus only comply with QM. Eventually, the electronic device 114, which may as indicated for instance be a switching device and may thus directly control the load 118, may put the load 118 in a safe state, e.g. an OFF state of a motor, such as by disconnecting the load 118 from the power supply 130.

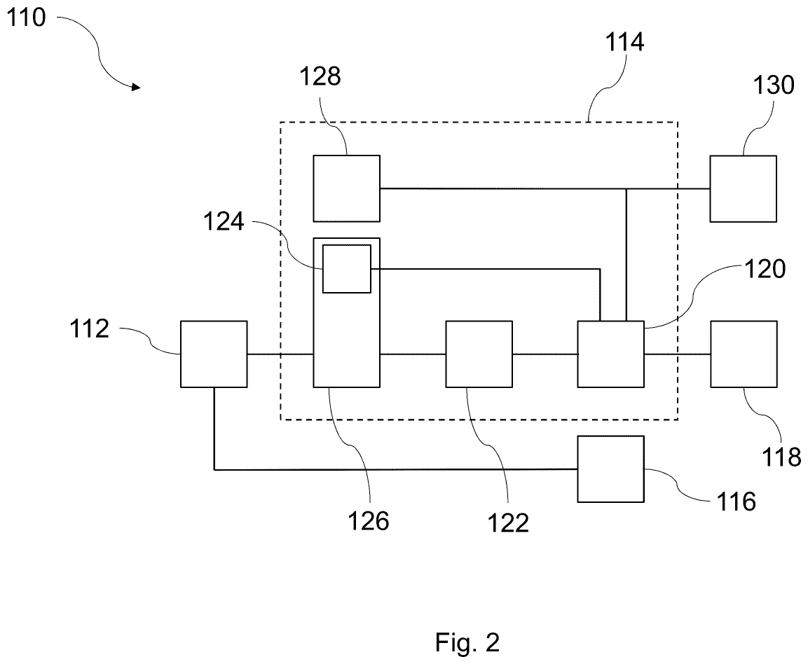

FIG. 2 schematically illustrates a further example of a control system 110. FIG. 2 corresponds to FIG. 1 at least to a large extent. Thus, for the description of FIG. 2, reference may also be made to the description of FIG. 1 at least to a large extent. FIG. 2 specifically indicates that the safe state trigger 124 may be part of the interface 126. In other words, the interface 126 may comprise the safe state trigger 124. As said, the interface 126 may specifically be or comprise a transceiver 126. Thus, the safe state trigger 124 may be part of the transceiver 126 or in other words the transceiver 126 may comprise the safe state trigger 124. As a result, the safe state trigger 124 may be configured for directly monitoring the communication between the supervising controller 112 and the electronic control unit 114. In case of a failure event, the safe state trigger 124 may register a failure signal from the supervising controller 112 and may consequently send a safe state signal directly to the electronic device 120 while bypassing the application controller 122. The interface 126 or specifically the transceiver 126 may comply with a safety requirement of the electronic control unit 114, for instance with SIL4 or ASIL D. Thus, overall, safety requirements of the electronic control unit 114 may still be met, even if the application controller 122 may only comply with a lower SIL.

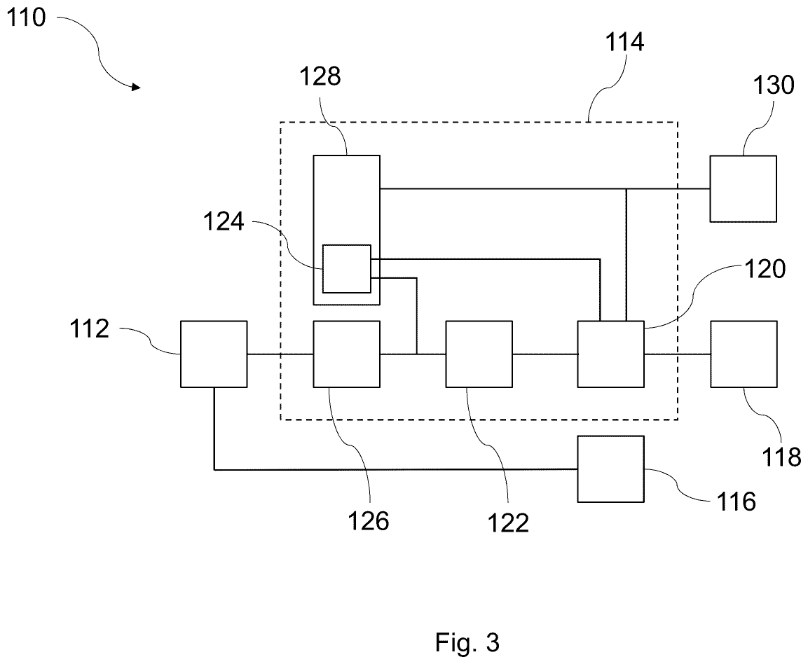

FIG. 3 schematically illustrates a further example of a control system 110. FIG. 3 corresponds to the previous figures at least to a large extent. Thus, for the description of FIG. 3, reference may also be made to the description of the previous figures at least to a large extent. FIG. 3 indicates that the safe state trigger 124 may also be part of the power adapter 128. In other words, the power adapter 128 may comprise the safe state trigger 124. As said, the power adapter 128 may specifically be or comprise a PMIC 128. Thus, the safe state trigger 124 may be part of the PMIC 128 or in other words the PMIC 128 may comprise the safe state trigger 124. The safe state trigger 124 may monitor a signal bus for identifying a failure signal from the supervising controller 112. When identifying the failure signal, the safe state trigger 124 may directly send a corresponding safe state signal to the electronic device 120 for triggering a safe state, e.g. a safe state of the load 118. Again, when doing so, the safe state trigger 124 may specifically bypass the application controller 122. The power adapter 128 or specifically the PMIC 128 may comply with a safety requirement of the electronic control unit 114, for instance with SIL4 or ASIL D. Thus, overall, safety requirements of the electronic control unit 114 may still be met, even if the application controller 122 may only comply with a lower SIL.

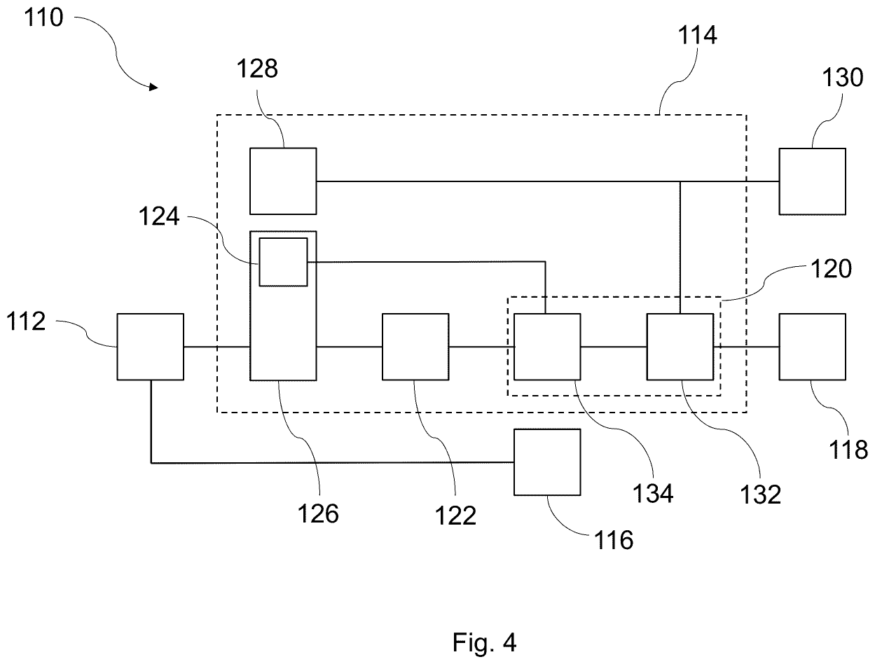

FIG. 4 schematically illustrates a further example of a control system 110. FIG. 4 corresponds to the previous figures at least to a large extent. Thus, for the description of FIG. 4, reference may also be made to the description of the previous figures at least to a large extent. As indicated, the electronic device 120 may be configured the load 118 and specifically for switching the load 118. Thus, the electronic device 120 may comprise at least one of a load switch 132 and a driver 134. As indicated in FIG. 4, the electronic device 120 may comprise a both elements, wherein the load switch 132 and the driver 134 may form a unit. Thus, the electronic device 120 may be a smart switch formed by the load switch 132 and the driver 134. However, in principle, the load switch 132 and the driver 134 may also be spatially separate or distant from each other. The load switch 132 may be a transistor, such as a metal-oxide-semiconductor field-effect transistor (MOSFET). The driver 134 may specifically be a gate driver. Thus, the gate driver 134 may be configured for controlling a gate of the MOSFET. The load switch 132 may correspondingly be configured for switching the load 118 on and off. As an example, in case of a failure event, the load switch 132 may switch the load 118 off for putting load 118 in a safe state. As already indicated before, the safe state trigger 124 may be part of the interface 126 and may monitor input signals from the supervising controller 112. When identifying a failure signal, the safe state trigger 124 may send a corresponding safe state signal to the driver 134 driving the load switch 132 and the load switch 132 may for instance switch off the load 118.

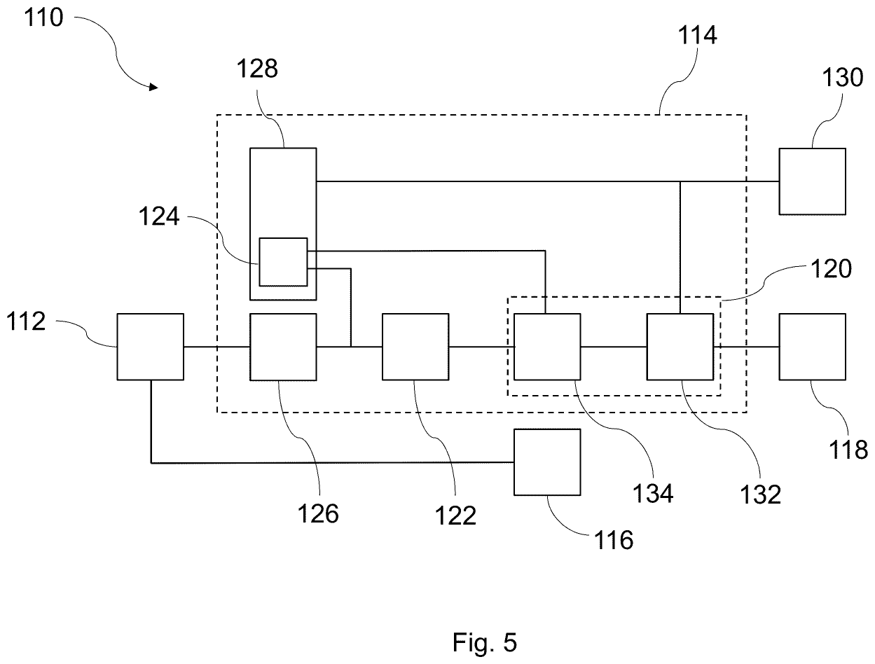

FIG. 5 schematically illustrates a further example of a control system 110. FIG. 5 corresponds to the previous figures at least to a large extent. Thus, for the description of FIG. 5, reference may also be made to the description of the previous figures at least to a large extent. As before, the electronic device 120 may be a smart switch formed by the load switch 132 and the driver 134. In this example, the safe state trigger 124 may however again be part of the power adapter 128. Thus, the safe state trigger 124 may monitor input signals from the supervising controller 112, such as by monitoring a signal bus. When identifying a failure signal, the safe state trigger 124 may send a corresponding safe state signal to the driver 134 driving the load switch 132 and the load switch 132 may for instance switch off the load 118.

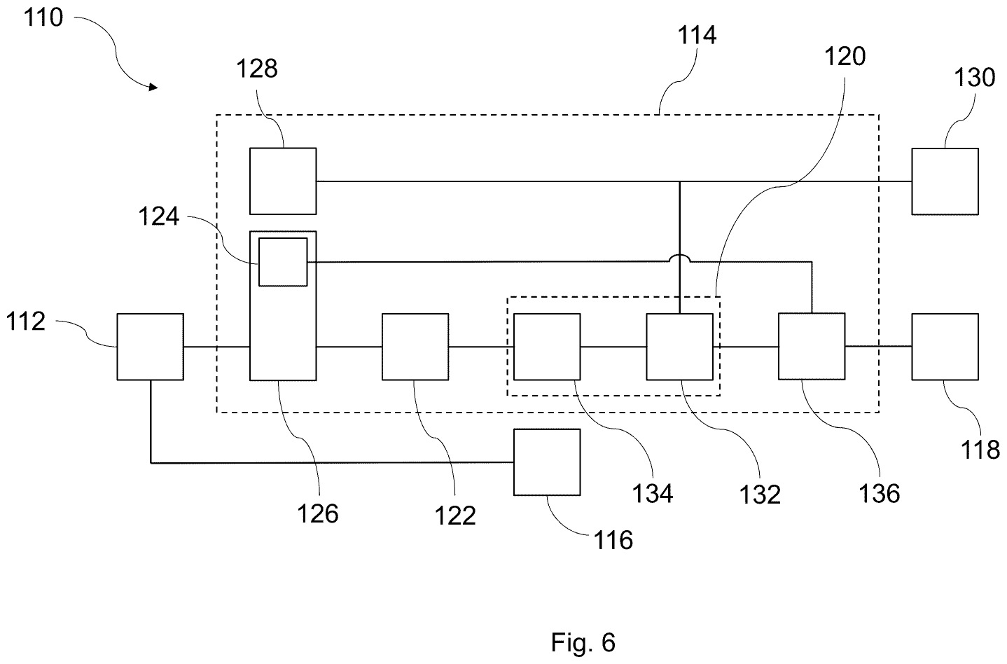

FIG. 6 schematically illustrates a further example of a control system 110. FIG. 6 corresponds to the previous figures at least to a large extent. Thus, for the description of FIG. 6, reference may also be made to the description of the previous figures at least to a large extent. FIG. 6 specifically indicates that the electronic control unit 114 may further comprise a safety switch 136. The safety switch 136 may for instance be an electromechanical switch. The safety switch 136 may be in a current path between the load switch 132 and the load 118. However, another position of the safety switch 136 may also be feasible, such as in a current path between the load switch 132 and the power supply 130. The safety switch 136 may specifically be connected to the safe state trigger 124. Thus, the safe state trigger 124 may directly send the safe state signal to the safety switch 136 while bypassing the application controller 122 and optionally further components, such as the driver 134. The safety switch 136 may then cut off the load 118 from the power supply 130, which may put the load 118 in a safe state. In the example depicted in FIG. 6, the safe state trigger 124 may be part of the interface 126. Other options may of course also be feasible.

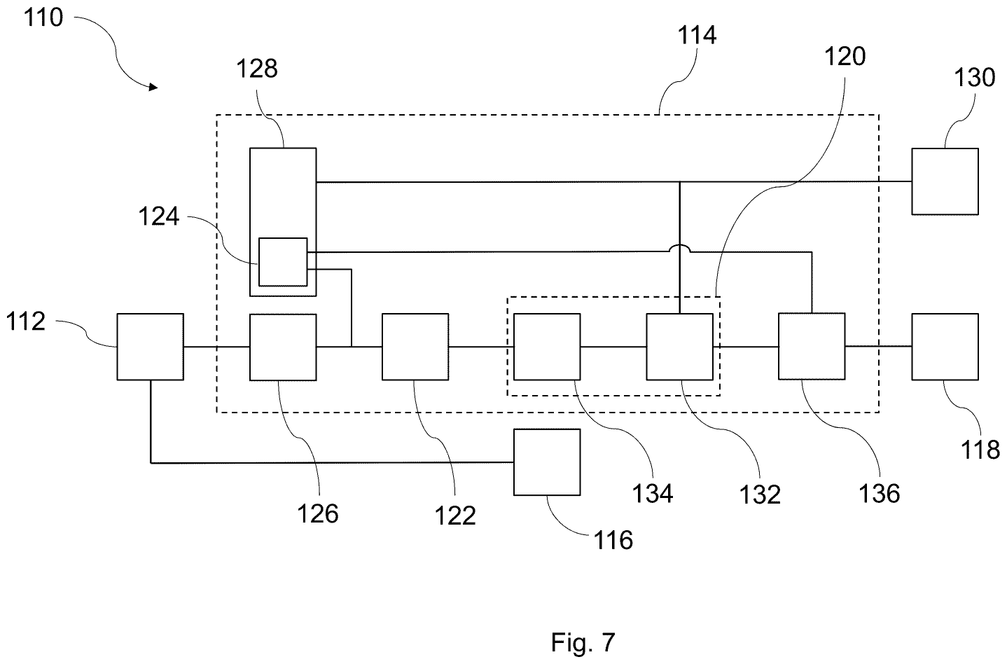

FIG. 7 schematically illustrates a further example of a control system 110. FIG. 7 corresponds to the previous figures at least to a large extent. Thus, for the description of FIG. 7, reference may also be made to the description of the previous figures at least to a large extent, specifically to FIG. 6. Different to the example depicted in FIG. 6, the example depicted in FIG. 7 illustrates that the safe state trigger 124 may be part of the power adapter 126 as already discussed before. Also in this configuration, when identifying a failure signal, the safe state trigger 124 may send a corresponding safe state signal to the safety switch 136 and the safety switch 136 may cut off the load 118 from the power supply 130, which may put the load 118 in a safe state.

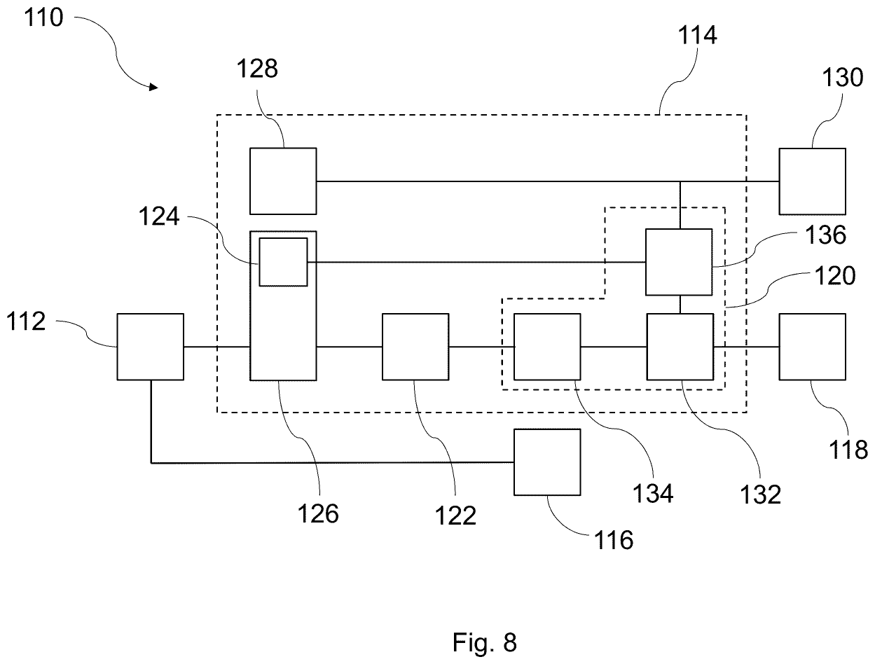

FIG. 8 schematically illustrates a further example of a control system 110. FIG. 8 corresponds to the previous figures at least to a large extent. Thus, for the description of FIG. 8, reference may also be made to the description of the previous figures at least to a large extent. FIG. 8 indicates that the electronic device 120 may comprise the safety switch 136. In other words, the safety switch 136 may be a part of the electronic device 120 or may be incorporated or implemented in the electronic device 120. The safety switch 136 may for instance be an electromechanical switch. The safety switch 136 may be in a current path between the load switch 132 and the power supply 130. Other options may however also be feasible, such as a position between the load switch 132 and the load 118 as described before. The safety switch 136 may further be connected to the safe state trigger 124. In this example, the safe state trigger 124 may be part of the interface 126. Thus, when identifying a failure signal, the safe state trigger 124 may send a corresponding safe state signal to the safety switch 136 and the safety switch 136 may cut off the load 118 from the power supply 130, which may put the load 118 in a safe state.

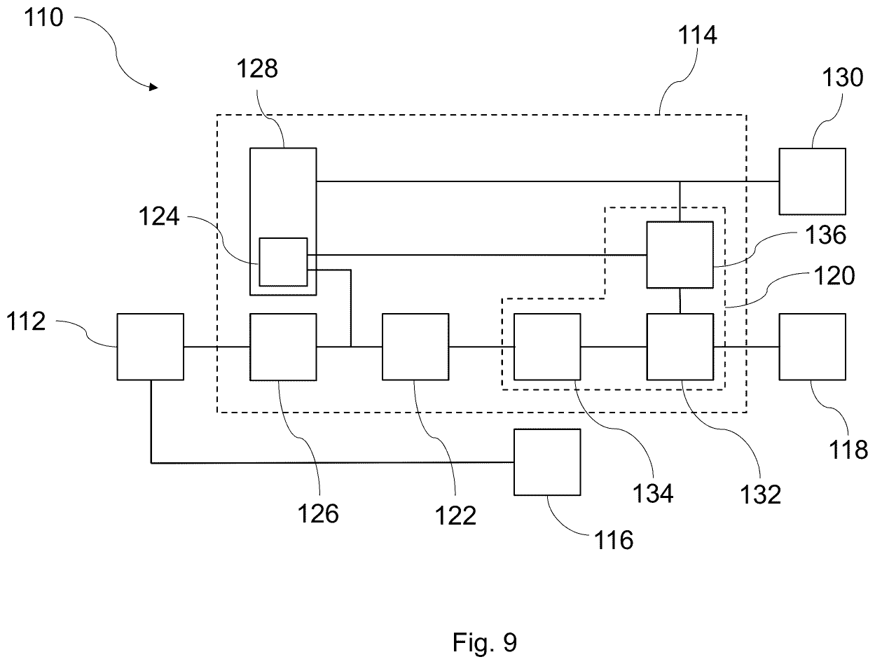

FIG. 9 schematically illustrates a further example of a control system 110. FIG. 9 corresponds to the previous figures at least to a large extent. Thus, for the description of FIG. 9, reference may also be made to the description of the previous figures at least to a large extent and specifically to FIG. 8. Different to the example depicted in FIG. 8, the example depicted in FIG. 9 illustrates that the safe state trigger 124 may be part of the power adapter 126 as already discussed before. Also in this configuration, when identifying a failure signal, the safe state trigger 124 may send a corresponding safe state signal to the safety switch 136 and the safety switch 136 may cut off the load 118 from the power supply 130, which may put the load 118 in a safe state.

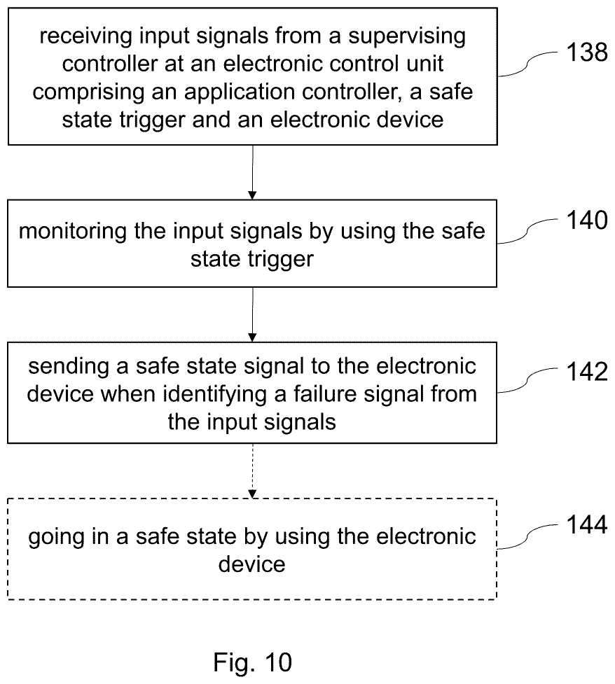

FIG. 10 illustrates a flow chart of an example of a method for triggering a safe state. The method comprises the following method steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion.
a) (denoted by reference numeral 138) receiving input signals from a supervising controller 112 at an electronic control 114 unit comprising an application controller 122, a safe state trigger 124 and an electronic device 120;
b) (denoted by reference numeral 140) monitoring the input signals by using the safe state trigger 124; and
c) (denoted by reference numeral 142) sending a safe state signal to the electronic device 120 when identifying a failure signal from the input signals; and optionally
d) (denoted by reference numeral 144) going in the safe state by using the electronic device 120.

Specifically, step d) may comprise putting the load 118 controlled by the electronic device 120 in the safe state, e.g. an OFF state. Step b) may comprise comparing the input signals with a predetermined fixed signal. Step c) may comprise sending the safe state signal to the electronic device 120 when an input signal matches the predetermined fixed signal. Step c) may further specifically comprise bypassing the application controller 122 when identifying the failure signal and sending the safe state signal to the electronic device 120.

The presented control system 110, the electronic control unit 114 and/or the method for triggering a safe state may specifically be used in an automotive application, such as for controlling a load in an automobile, e.g. a motor in an automobile. Other uses may of course also be conceivable.

In addition to the above described examples, the following examples are disclosed herein:

Example 1: An electronic control unit comprising at least:
an electronic device;
an application controller configured for controlling the electronic device; and
a safe state trigger configured for:
   monitoring input signals sent from a supervising controller to the electronic control unit;
   identifying a failure signal from the input signals; and sending a safe state signal to the electronic device when identifying the failure signal.

Example 2: The electronic control unit according to the preceding Example, wherein the safe state trigger and the application controller are separate components of the electronic control unit.

Example 3: The electronic control unit according to any one of the preceding Examples, wherein the safe state trigger is configured for bypassing the application controller when identifying the failure signal and sending the safe state signal to the electronic device.

Example 4: The electronic control unit according to any one of the preceding Examples, wherein the application controller complies with a safety integrity level (SIL) lower than the SIL of a safety requirement of the electronic control unit, specifically lower than SIL4, more specifically with an automotive safety integrity level (ASIL) lower than ASIL D.

Example 5: The electronic control unit according to any one of the preceding Examples, wherein the safe state trigger complies with a SIL derived from a safety requirement of the electronic control unit, specifically with SIL4, more specifically with ASIL D.

Example 6: The electronic control unit according to any one of the preceding Examples, wherein the safe state trigger is configured for triggering a safe state in case of a failure event by sending the safe state signal to the electronic device.

Example 7: The electronic control unit according to the preceding Example, wherein the safe state is a safe state of a load controlled by the electronic control unit, specifically by the electronic device.

Example 8: The electronic control unit according to any one of the two preceding Examples, wherein the safe state trigger is further configured for triggering a transition mode of the electronic control unit for achieving the safe state.

Example 9: The electronic control unit according to any one of the three preceding Examples, wherein the safe state comprises at least one of an OFF state and an ON state.

Example 10: The electronic control unit according to any one of the preceding Examples, wherein the safe state trigger comprises at least one signal filter configured for comparing the input signals with a predetermined fixed signal for identifying the failure signal.

Example 11: The electronic control unit according to the preceding Example, wherein the safe state trigger is configured for sending the safe state signal when an input signal matches the predetermined fixed signal

Example 12: The electronic control unit according to any one of the two preceding Examples, wherein the signal filter complies with a SIL of a safety requirement of the electronic control unit, specifically with SIL4, more specifically with ASIL D.

Example 13: The electronic control unit according to any one of the three preceding Examples, wherein the signal filter is a digital signal filter.

Example 14: The electronic control unit according to any one of the preceding Examples, wherein the input signals sent from the supervising controller comprise digital signals.

Example 15: The electronic control unit according to any one of the preceding Examples, wherein the failure signal is a digital signal.

Example 16: The electronic control unit according to any one of the preceding Examples, wherein the electronic control unit comprises an interface configured for connecting the electronic control unit to at least the supervising controller, wherein the safe state trigger is a part of the interface

Example 17: The electronic control unit according to the preceding Example, wherein the interface is further configured for at least partially interconnecting at least the electronic device, the application controller and the safe state trigger within the electronic control unit.

Example 18: The electronic control unit according to any one of the two preceding Examples, wherein the interface comprises at least one transceiver for communication with the supervising controller, wherein the safe state trigger is a part of the transceiver.

Example 19: The electronic control unit according to the preceding Example, wherein the transceiver complies with a SIL of a safety requirement of the electronic control unit, specifically with SIL4, more specifically with ASIL D.

Example 20: The electronic control unit according to any one of the four preceding Examples, wherein the interface comprises at least one bus for signal transfer.

Example 21: The electronic control unit according to the preceding Example, wherein the safe state trigger is configured for sniffing the signal transfer on the bus.

Example 22: The electronic control unit according to any one of the preceding Examples, further comprising a power adapter, wherein the safe state trigger is a part of the power adapter.

Example 23: The electronic control unit according to the preceding Example, wherein the power adapter complies with a SIL derived from a safety requirement of the electronic control unit, specifically with SIL4, more specifically with an ASIL D.

Example 24: The electronic control unit according to any one of the two preceding Examples, wherein the power adapter is a power management integrated circuit (PMIC).

Example 25: The electronic control unit according to any one of the three preceding Examples, wherein the power adapter is configured for being connected to at least one power supply, specifically to at least one battery.

Example 26: The electronic control unit according to any one of the preceding Examples, wherein the electronic device is configured for controlling a load.

Example 27: The electronic device according to the preceding Example, wherein the electronic device comprises at least one of a load switch and a driver.

Example 28: The electronic control unit according to the preceding Example, wherein the electronic device is a smart switch formed by the load switch and the driver.

Example 29: The electronic control unit according to the preceding Example, wherein the electronic device further comprises a safety switch.

Example 30: The electronic control unit according to the preceding Example, wherein the safety switch is in a current path between the load switch and a power supply, wherein the safety switch is connected to the safe state trigger.

Example 31: The electronic control unit according to any one of the preceding Examples, wherein the failure signal is based on sensor data processed by the supervising controller.

Example 32: The electronic control unit according to any one of the preceding Examples, wherein the application controller is a microcontroller.

Example 33: The electronic control unit according to any one of the preceding Examples, wherein the application controller is configured for receiving and processing the input signals from the supervising controller for controlling the electronic device.

Example 34: A method for triggering a safe state, the method comprising:
a) receiving input signals from a supervising controller at an electronic control unit comprising an application controller, a safe state trigger and an electronic device;
b) monitoring the input signals by using the safe state trigger; and
c) sending a safe state signal to the electronic device when identifying a failure signal from the input signals

Example 35: The method according to the preceding Example, wherein the electronic control unit is an electronic control unit according to any one of the preceding Examples referring to an electronic control unit.

Example 36: The method according to any one of the preceding method Examples, further comprising:
d) going in the safe state by using the electronic device.

Example 37: The method according to the preceding Example, wherein step d) comprises putting a load controlled by the electronic device in the safe state.

Example 38: The method according to any one of the preceding method Examples, wherein step b) comprises comparing the input signals with a predetermined fixed signal.

Example 39: The method according to the preceding Example, wherein step c) comprises sending the safe state signal to the electronic device when an input signal matches the predetermined fixed signal.

Example 40: The method according to any one of the preceding method Examples, wherein step c) comprises bypassing the application controller when identifying the failure signal and sending the safe state signal to the electronic device.

Example 41: A control system comprising:
a supervising controller configured for controlling at least one electronic control unit; and
at least one electronic control unit, wherein the electronic control unit comprises:
   an electronic device;
   an application controller configured for controlling the electronic device; and
   a safe state trigger configured for:
      monitoring input signals sent from a supervising controller to the electronic control unit;
      identifying a failure signal from the input signals; and
      sending a safe state signal to the electronic device when identifying the failure signal.

Example 42: The control system according to the preceding Example, wherein the electronic control unit is an electronic control unit according to any one of the preceding Examples referring to an electronic control unit.

Example 43: The control system according to any one of the preceding Examples referring to a control system, wherein the supervising controller complies with a SIL derived from of a safety requirement of the electronic control unit, specifically with SIL4, more specifically with ASIL D.

Example 44: The control system according to any one of the preceding Examples referring to a control system, wherein the supervising controller is a zone controller or a central controller.

Example 45: The control system according to any one of the preceding Examples referring to a control system, wherein the supervising controller is a supervising electronic control unit or at least a part thereof.

Example 46: The control system according to any one of the preceding Examples referring to a control system, wherein the supervising controller is a microcontroller, specifically a main microcontroller of the control system.

Example 47: The control system according to any one of the preceding Examples referring to a control system, further comprising at least one sensor configured for observing the control system or at least a part thereof, wherein the supervising controller is configured for processing sensor data from the sensor.

Example 48: The control system according to the preceding Example, wherein the sensor is configured for observing at least one of the electronic control unit and a load controlled by the electronic control unit.

Example 49: The control system according to any one of the two preceding Examples, wherein the sensor is configured for detecting a failure event, wherein the supervising controller is configured for generating a failure signal in case of the failure event based on the sensor data.

Example 50: The control system according to any one of the preceding Examples referring to a control system, further comprising at least one load controlled by the electronic control unit and specifically by the electronic device.

Example 51: The control system according to the preceding Example, wherein the load comprises at least one motor.

Example 52: The control system according to any one of the preceding Examples referring to a control system, further comprising at least one power supply, specifically a battery.

Example 53: A use for an automotive application of at least one of the electronic control unit according to any one of the preceding Examples referring to an electronic control unit, a method for triggering a safe state according to any one of the preceding method Examples and a control system according to any one of the preceding Examples referring to a control system.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1: An electronic control unit comprising:
an electronic device;
an application controller configured to control the electronic device; and
a safe state trigger configured to:
monitor input signals sent from a supervising controller to the electronic control unit;
identify a failure signal from the input signals; and
send a safe state signal to the electronic device when identifying the failure signal.

2: The electronic control unit according to claim 1, wherein the safe state trigger is configured to bypass the application controller when identifying the failure signal and sending the safe state signal to the electronic device.

3: The electronic control unit according to claim 1, wherein the application controller complies with a safety integrity level (SIL) lower than the SIL of a safety requirement of the electronic control unit, lower than SIL4, and with an automotive safety integrity level (ASIL) lower than ASIL D.

4: The electronic control unit according to claim 1, wherein the safe state trigger complies with a safety integrity level (SIL) derived from a safety requirement of the electronic control unit, with SIL4, and with an automotive safety integrity level (ASIL) D.

5: The electronic control unit according to claim 1, wherein the safe state trigger is configured to trigger a safe state in case of a failure event by sending the safe state signal to the electronic device.

6: The electronic control unit according to claim 5, wherein the safe state trigger is further configured to trigger a transition mode of the electronic control unit for achieving the safe state.

7: The electronic control unit according to claim 5, wherein the safe state comprises at least one of an OFF state and an ON state.

8: The electronic control unit according to claim 1, wherein the safe state trigger comprises at least one signal filter configured to compare the input signals with a predetermined fixed signal for identifying the failure signal.

9: The electronic control unit according to claim 8, wherein the safe state trigger is configured to send the safe state signal when an input signal matches the predetermined fixed signal.

10: The electronic control unit according to claim 8, wherein the signal filter comprises a digital signal filter.

11: The electronic control unit according to claim 1, wherein the electronic control unit comprises an interface configured to connect the electronic control unit to at least the supervising controller, wherein the safe state trigger is a part of the interface.

12: The electronic control unit according to claim 11, wherein the interface comprises at least one transceiver for communication with the supervising controller, wherein the safe state trigger is a part of the transceiver.

13: The electronic control unit according to claim 1, further comprising a power adapter, wherein the safe state trigger is a part of the power adapter.

14: The electronic control unit according to claim 1, wherein the electronic device is configured to control a load, wherein the electronic device comprises at least one of a load switch and a driver.

15: The electronic control unit according to claim 14, wherein the electronic device comprises a smart switch formed by the load switch and the driver, wherein the electronic device further comprises a safety switch.

16: A method for triggering a safe state, the method comprising:
a) receiving input signals from a supervising controller at an electronic control unit comprising an application controller, a safe state trigger, and an electronic device;
b) monitoring the input signals by using the safe state trigger; and
c) sending a safe state signal to the electronic device when identifying a failure signal from the input signals.

17: The method according to claim 16, further comprising:
d) going in the safe state by using the electronic device.

18: A control system comprising:
a supervising controller configured to control at least one electronic control unit; and
the at least one electronic control unit, wherein the electronic control unit comprises:
an electronic device;
an application controller configured to control the electronic device; and
a safe state trigger configured to:
monitor input signals sent from a supervising controller to the electronic control unit;
identify a failure signal from the input signals; and
send a safe state signal to the electronic device when identifying the failure signal.

19: The control system according to claim 18, wherein the supervising controller complies with a safety integrity level (SIL) derived from of a safety requirement of the electronic control unit, with SIL4, and with automotive safety integrity level (ASIL) D.
